(19) United States
(12) Patent Application Publication
(10) Pub. No.: US 2025/0018687 A1
(43) Pub. Date: Jan. 16, 2025

(54) LAMINATED GLASS AND VEHICLE

(71) Applicant: FUYAO GLASS INDUSTRY GROUP CO., LTD., Fuqing Fuzhou (CN)

(72) Inventors: Zhe WANG, Fuqing (CN); Jun LIN, Fuqing (CN); Li WANG, Fuqing (CN); Bizhu CHEN, Fuqing (CN)

(21) Appl. No.: 18/714,650

(22) PCT Filed: Apr. 4, 2023
(86) PCT No.: PCT/CN2023/086058

§ 371 Date: May 30, 2024

(30) Foreign Application Priority Data
Apr. 6, 2022 (CN) 202210356287.6

(51) Int. Cl. B32B 17/10

(52) U.S. Cl. CPC B32B 17/10293; B32B 17/10036; B32B 2307/546; B32B 2307/7376; B32B 2605/00

(57) ABSTRACT

In one aspect, a laminated glass includes first and second glass plates and at least two connectors, with the thickness of the second glass plate being not larger than 1.6 mm and a middle layer being arranged between the first glass plate and the second glass plate. Each connector comprises an embedded part. The embedded part is arranged between the middle layer and the second glass plate, so as to be in contact with the middle layer and the second glass plate at the same time. The laminated glass has a clinging value A=T₁×T₂×L/(T₃)³, and the clinging value A is at least 20, wherein the thickness of the second glass plate is T₁, the thickness of the intermediate layer is T₂, the thickness of the embedded part is T₃, and the distance between the embedded parts of two adjacent connectors is L.

### CROSS-REFERENCE TO RELATED APPLICATIONS

This application claims priority of Chinese Patent Application No. 2022103562876, filed on Apr. 6, 2022, entitled “LAMINATED GLASS AND VEHICLE”, the content of which is hereby incorporated by reference in its entirety.

### TECHNICAL FIELD

The present disclosure relates to the technical field of glass structures, and in particular to a laminated glass and a vehicle.

### BACKGROUND

Laminated glass with electrification function needs to adopt an internally embedded wiring harness connector, which is led from a welding point or a busbar on the inner surface of the laminated glass to the outside of the glass, so as to form a raised area where there is the connector. Conventional laminated glass for vehicle relies on the sufficient thickness and rigidity of the inner and outer plates of glass. During the pressing process, PVB (polyvinyl butyral) can be fully compressed at the vacuum stage, so as to discharge bubbles at a junction between the raised area and other PVB areas. During the high-pressure process, the PVB can fully fill gaps at the junction, thereby avoiding the generation of laminated bubbles in a joint area. However, when the glass constituting the laminated glass is thin, a surface pressure formed by the thin glass decreases during the vacuumizing process of the laminated glass, which may cause the bubbles at the junction between the raised area of an embedding portion of an embedded member and other areas to be unable to be completely discharged, and the bubbles are formed after the high pressure.

### SUMMARY

According to various embodiments of the present disclosure, a laminated glass and a vehicle capable of preventing the generation of bubbles are provided.

The technical solution is as follows:

A laminated glass includes:
a first glass plate;
a second glass plate having a thickness no greater than 1.6 mm;
an intermediate laver provided between the first glass plate and the second glass plate; and
at least two connectors, the connector including an embedding portion provided between the intermediate layer and the second glass plate, and the embedding portion being in contact with both the intermediate layer and the second glass plate;
wherein the laminated glass has a close contact value A satisfying A=T₁×T₂×L/(T₃)³, and the close contact value A is at least 20, wherein T₁ is the thickness of the second glass plate. T₂ is a thickness of the intermediate layer, T₃ is a thickness of the embedding portion, and L is a distance between adjacent two embedding portions.

In an embodiment, the thickness of the second glass plate is no greater than 1.2 mm.

In an embodiment, the close contact value A is at least 30.

In an embodiment, 0.5 mm≤T₁≤1.2 mm.

In an embodiment, a thickness of the first glass plate is greater than or equal to 2.1 mm.

In an embodiment, L≥25 mm.

In an embodiment, 0.38 mm≤T₂≤1.52 mm.

In an embodiment, 0.2 mm≤T₃≤51 mm.

In an embodiment, an elastic modulus of the intermediate layer is less than or equal to 10 MPa.

In an embodiment, the embedding portion includes a main body and an auxiliary bonding layer, and when the embedding portion is in contact with the first glass plate, the auxiliary bonding layer is provided between the main body and the first glass plate;
or when the embedding portion is in contact with the second glass plate, the auxiliary bonding layer is provided between the main body and the second glass plate.

In an embodiment, a thickness of the auxiliary bonding layer is less than or equal to 0.3 mm.

In an embodiment, the embedding portion is provided with a rough surface configured to be bonded to the intermediate layer.

In an embodiment, when the intermediate layer is a single-layer structure, the embedding portions are located between the intermediate layer and the first glass plate; or the embedding portions are located between the intermediate layer and the second glass plate; or the embedding portions are located in the intermediate layer;
when the intermediate layer is a multi-layer structure, the embedding portions are located on the same side of the intermediate layer; or the intermediate layer includes at least two layers of split bodies, and all the embedding portions are located between adjacent two split bodies.

In an embodiment, the connector further includes an external connecting portion connected to the embedding portion, the external connecting portion is located outside the intermediate layer, and the external connecting portion is bent toward the second glass plate and is bonded to a side surface of the second glass plate away from the intermediate layer.

A vehicle includes any one of the foregoing laminated glasses.

### BRIEF DESCRIPTION OF THE DRAWINGS

in order to illustrate the embodiments of the present disclosure more clearly, the drawings used in the embodiments will be described briefly. Apparently, the following described drawings are merely for the embodiments of the present disclosure, and other drawings can be derived by those of ordinary skill in the art without any creative effort.

FIG. 1 is a schematic view of a laminated glass according to an embodiment of the present disclosure.

FIG. 2 is a partial sectional view of the laminated glass according to an embodiment of the present disclosure.

### DESCRIPTION OF REFERENCE SIGNS

100. First glass plate, 200. Second glass plate; 300. Intermediate layer; 400. Connector; 410. Embedding portion; 420. External connection portion.

### DETAILED DESCRIPTION OF THE EMBODIMENTS

The technical solution in the embodiment of the present disclosure will be clearly and completely described below in conjunction with the drawings in the embodiment of the application. Apparently, the described embodiments are only some of the embodiments of the application, not all of them. Based on the embodiments in the present disclosure, all other embodiments obtained by a person skilled in the art without creative efforts shall all fall within the protection scope of the present disclosure.

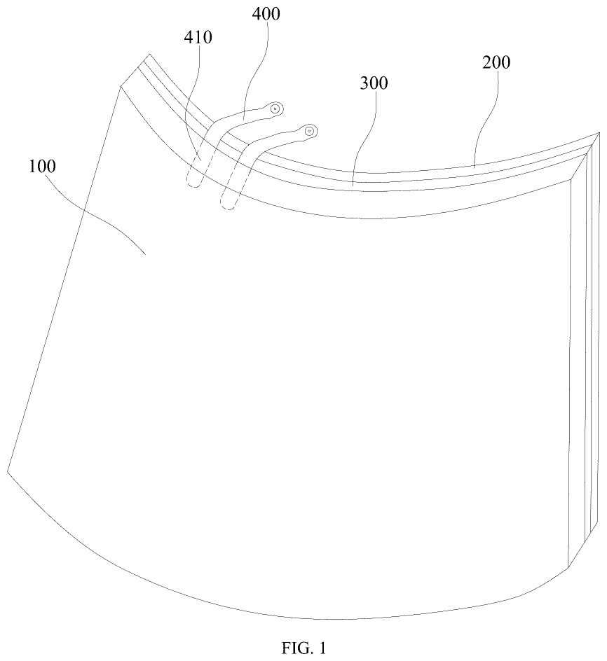

As shown in FIG. 1, a laminated glass is provided according to an embodiment, including a first glass plate 100, a second glass plate 200, an intermediate layer 300, and connectors 400. A thickness of the second glass plate 200 is not greater than 1.2 mm. The intermediate layer 300 is provided between the first glass plate 100 and the second glass plate 200. At least two connectors 400 are provided, the connector 400 includes an embedding portion 410 provided between the intermediate layer 300 and the second glass plate 200, so as to be in contact with both the intermediate layer and the second glass plate 200. The laminated glass has a close contact value A satisfying A=T₁×T₂×L/(T₃)³ and the close contact value A is at least 20. The thickness of the second glass plate 200 is T₁, a thickness of the intermediate layer 300 is T₂, a thickness of the embedding portion 410 is T₃, and a distance between the embedding portions 410 of two adjacent connectors 400 is L.

According to the aforementioned laminated glass, the intermediate layer 300 is located between the first glass plate 100 and the second glass plate 200, the connector 400 can be configured to be connected to an external circuit. The thickness of the embedding portion 410 is less than the thickness of the intermediate layer 300, such that the embedding portion 410 will not be in contact with the first glass plate 100 and the second glass plate 200 at the same time during pressing, instead at least one side of the embedding portion 410 is in contact with the intermediate layer 300, so as to prevent pressing failure. The close contact value A is obtained by dividing a product of the thickness T₁ of the second glass plate 200, the thickness T₂ of the intermediate layer 300, and the distance L between the embedding portions 410 of the two adjacent connectors 400 by a cube of the thickness T₃ of the embedding portion 410. The close contact value A is ensured to be at least 20, at this time, even if the thickness of the second glass plate 200 is not greater than 1.2 mm, the surface pressure that the second glass plate 200 can provide during pressing is small, and the thickness of the embedding portion 410 may cause the intermediate layer 300 to partially protrude. However, after pressing and heating, bubbles are unlikely to be generated around the embedding portion 410, which provides a better appearance effect.

In addition, when the second glass plate 200 is relatively thick, a greater surface pressure can be provided during pressing. At this time, the probability of generating bubbles in the vicinity of the embedding portion 410 after pressing and heating is reduced. When the thickness of the second glass plate 200 is less than or equal to 1.2 mm, the second glass plate 200 is thinner and can withstand less force during pressing, and accordingly can provide a smaller surface pressure. At this time, the values of T₁, T₂, T₃, and L are limited to enable the close contact value A to be at least 20, so as to ensure that no bubbles are generated in the vicinity of the embedding portion 410 after pressing and/or heating.

In other embodiments. 1.2 mm≤T₁≤1.6 mm. When the thickness of the second glass plate 200 is less than or equal to 1.6 mm and greater than 1.2 mm, the surface pressure provided by the second glass plate 200 during pressing is still relatively small, and the possibility of generating bubbles cannot be completely eliminated. Therefore, T₁ can also be used as a parameter for processing and compared with the close contact value A to ensure that no bubbles are generated in the vicinity of the embedding portion 410 after pressing and/or heating. For example, T₁ may be 1.2 mm, 1.3 mm, 1.4 mm, 1.5 mm, or 1.6 mm.

Since at least one side surface of the embedding portion 410 is in contact with the intermediate layer 300, both sides of the embedding portion 410 can be prevented from being in direct contact with the first glass plate 100 and the second glass plate 200, respectively, thereby preventing damage to the first glass plate 100 or the second glass plate 200 during pressing, while ensuring that the intermediate layer 300 can fully cover the embedding portion 410, and reducing the generation of bubbles in the vicinity of the embedding portion 410.

Actually, since the thickness of the intermediate layer 300 is greater than that the thickness of the embedding portion 410, when the embedding portion 410 is embedded into the intermediate layer 300, the embedding portion 410 will not be in contact with the first glass plate 100 and the second glass plate 200, respectively. However, it is necessary to ensure that at least one side surface of the intermediate layer 300 is in contact with the embedding portion 410, so as to prevent voids or bubbles from occurring between the embedding portion 410 and the first glass plate 100 or the second glass plate 200.

Optionally, the intermediate layer 300 is configured to be bonded to the first glass plate 100 and the second glass plate 200, respectively. Specifically, the intermediate layer 300 is also made of a light-transmitting material, so that the entire laminated glass can transmit light.

Optionally, a built-in circuit is provided on a surface or an interior of the intermediate layer 300, the embedding portion 410 is electrically connected to the built-in circuit, and the built-in circuit has functions such as energizing, heating, and displaying.

Optionally, the embedding portion 410 of the connector 400 may be a metal foil such as an aluminum foil or a copper foil. Alternatively, the embedding portion 410 has a composite plate-shaped structure having a core layer, the core layer is a metal foil, and the core layer is coated with an organic polymer film;

Alternatively, the embedding portion 410 of the connector 400 may be circular or elliptical, and the maximum diameter of the embedding portion 410 in a thickness direction of the first glass plate 100 or the second glass plate 200 is the thickness of the embedding portion 410.

Optionally, a thickness difference of the embedding portion 410 of the connector 400 is less than or equal to 0.3 mm. At this time, a difference in the thickness at various locations on the embedding portion 410 410 is relatively small, which can reduce the possibility of generating bubbles during the pressing and heating.

In addition, in addition to having the first glass plate 100 and the second glass plate 200, the laminated glass may further have other light-transmitting members. Different light-transmitting members are stacked, and the intermediate layer 300 is provided between adjacent two light-transmitting members. If one of the intermediate layers 300 is embedded with the embedding portions 410 of the at least two connectors 400, the close contact value A also needs to be greater than or equal to the close contact value A.

In an embodiment, the close contact value A is at least 30. When the close contact value A is at least 30, the laminated glass is less likely to generate bubbles in the vicinity of the embedding portion 410 even after processing such as pressing and heating, and has better product performance.

In the specific embodiment, the close contact value A is greater than or equal to 30, which can prevent the bubbles from being generated in the vicinity of the embedding portion 410 during the pressing and heating.

In other embodiments, according to different use environments of the laminated glass, the close contact value A may be configured to be a smaller value. For example, if only pressing is required and the laminated glass after pressing does not need to be heated or the heating temperature is low, the close contact value A may be configured to be less than 30 and greater than or equal to 20. For example, the close contact value A may be 20, 21, 22, 23, 24, 25, 26, 27, 28, or 29.

In an embodiment, 0.5 mm≤T₁≤1.2 mm. Since the second glass plate 200 needs to have a certain thickness to prevent breakage during pressing and subsequent use, the thickness of the second glass plate 200 is set to be less than or equal to 1.2 mm and greater than or equal to 0.5 mm. At this time, the second glass plate 200 is relatively thin and has a certain strength, and bubbles are prevented by configuring the close contact value A to be at least 20 mm, so that the laminated glass has better product performance and yield.

In other embodiments, according to different materials of the second glass plate 200, the thickness T₁ of the second glass plate 200 may also be less than 0.5 mm, for example, the thickness T₁ may be 0.4 mm, 0.3 mm, 0.2 mm, or 0.1 mm.

In an embodiment, the thickness of the first glass plate 100 is greater than or equal to 2.1 mm. The thickness of the second glass plate 200 is less than the thickness of the first glass plate 100, while the processed laminated glass still needs to have a certain thickness to maintain the strength, and provide sufficient surface pressure during pressing, so that the thickness of the first glass plate 100 is configured to be greater than or equal to 2.1 mm.

In other embodiments, according to different material, processing process, or use requirements of the first glass plate 1X), the thickness of the first glass plate 100 may be greater than 1.2 mm and less than 2.1 mm. For example, the thickness of the first glass plate 100 may be 1.3 mm, 1.4 mm, 1.5 mm, 1.6 mm, 1.7 mm, 1.8 mm, 1.9 mm, or 2.0 mm.

In an embodiment, L≥5 mm. When L is relatively small, the distance between the two adjacent embedding portions 410 is too small, which causes the intermediate layer 300 to be more difficult to fill a space between the two adjacent embedding portions 410 during pressing, and bubbles are easily generated. Therefore, L is configured to be greater than or equal to 5 mm.

In other embodiments, by increasing the fluidity of the intermediate layer 300 under pressure and heat, or increasing the vacuum or pressure during pressing, L may also be less than 5 mm, for example, L may be 4 mm, 3 mm, 2 mm or 1 mm.

In an embodiment, 0.38 mm≤T₂≤1.52 mm. The thickness of the intermediate layer 300 should not be too large, and the intermediate layer 300 needs to be able to be bonded to the first glass plate 100 and the second glass plate 200, respectively, so that the thickness T₂ of the intermediate layer 300 is set to be 0.38 mm to 1.52 mm.

Alternatively, T₂ may be 0.38 mm, 0.76 mm, 1.14 mm, or 1.52 mm. Certainly, T₂ may also be any value within the range of 0.38 mm to 1.52 mm.

In an embodiment, 0.2 mm≤T₃≤1 mm. The thickness of the embedding portion 410 cannot be too large, so the thickness of the embedding portion 410 is set to 0.2 mm to 1 mm.

Alternatively, T₃ may be 0.2 mm, 0.3 mm, 0.4 mm, 0.5 mm, 0.6 mm, 0.7 mm, 0.8 mm, 0.9 mm or 1 mm. Certainly. T₃ may also be any value within the range of 0.2 mm to 1 mm.

In other embodiments, according to different use requirements of the laminated glass, provided the close contact value A is at least 20, T₂ and T₃ may also be other values.

By using different values of T₁, T₂, T₃, and L, different close contact values A are obtained, values as shown in the following table:

| | | | T₃/mm | | | |
|---|---|---|---|---|---|---|
| | | | | Thickness of an | | |
| | | | Thickness of a | auxiliary bonding | | |
| | | | main body of the | layer of the | | |
| | | | embedding | embedding | | Close contact |
| No. | T₁/mm | T₂/mm | portion | portion | L/mm | value A |
| Example 1 | 0.5 | 0.38 | 0.2 | 0 | 5 | 119 |
| Example 2 | 0.5 | 0.76 | 0.2 | 0.1 | 5 | 70 |
| Example 3 | 0.7 | 0.76 | 0.2 | 0.1 | 5 | 99 |
| Example 4 | 0.7 | 0.76 | 0.3 | 0.2 | 12 | 51 |
| Example 5 | 0.7 | 0.76 | 0.4 | 0 | 10 | 83 |
| Example 6 | 0.7 | 0.76 | 0.5 | 0 | 12 | 51 |
| Example 7 | 0.7 | 0.38 | 0.3 | 0 | 6 | 59 |
| Example 8 | 1.1 | 0.76 | 0.5 | 0.1 | 12 | 46 |
| Example 9 | 1.1 | 1.14 | 0.7 | 0.1 | 20 | 49 |
| Example 10 | 1.1 | 0.76 | 0.7 | 0 | 14 | 34 |
| Comparative | 0.7 | 0.76 | 0.8 | 0 | 5 | 5 |
| Example 1 | | | | | | |
| Comparative | 0.7 | 0.76 | 0.6 | 0.2 | 5 | 5 |
| Example 2 | | | | | | |
| Comparative | 0.7 | 0.76 | 0.6 | 0 | 5 | 12 |
| Example 3 | | | | | | |
| Comparative | 1.1 | 0.38 | 0.6 | 0 | 10 | 19 |
| Example 4 | | | | | | |
| Comparative | 1.1 | 0.76 | 0.8 | 0 | 16 | 26 |
| Example 5 | | | | | | |

In examples 1 to 10, the close contact value A is greater than or equal to 30. In comparative examples 1 to 4, the close contact value A is less than 20. In comparative example 5, the close contact value A is between 20 and 30.

After the laminated glasses in the above examples and the comparative examples are pressed and subjected to the heat resistance test, the results in the vicinity of the embedding portion 410 are different, as shown in the following table:

| | Bubble condition after pressing | | | | Bubble condition after heat resistance test | | | |
|---|---|---|---|---|---|---|---|---|
| | Whether | | | | | | | Maximum |
| | there are | | | Maximum | Whether new | New | New | diameter |
| | bubbles | Bubble | Bubble | diameter/ | bubbles are | bubble | bubble | of new |
| No. | or not | position | density | mm | generated | position | density | bubble/mm |
| Example 1 | No | / | / | / | No | / | / | / |
| Example 2 | No | / | / | / | No | / | / | / |
| Example 3 | No | / | / | / | No | / | | / |
| Example 4 | No | / | / | / | No | / | / | / |
| Example 5 | No | / | / | / | No | / | / | / |
| Example 6 | No | / | / | / | No | / | / | / |
| Example 7 | No | / | / | / | No | / | / | / |
| Example 8 | No | / | / | / | No | / | / | / |
| Example 9 | No | / | / | / | No | / | / | / |
| Example 10 | No | / | / | / | No | / | / | / |
| Comparative | Yes | Between | Sparse | 3 | Original | Between | Sparse | 4 |
| example 1 | | embedding | large | | bubble | embedding | large | |
| | | portions | bubble | | grows | portions | bubble | |
| Comparative | Yes | Between | Sparse | 3 | Original | Between | Sparse | 4 |
| example 2 | | embedding | large | | bubble | embedding | large | |
| | | portions | bubble | | grows | portions | bubble | |
| Comparative | Yes | In the | Dense | 1.5 | Original | In the | Dense | 2.5 |
| example 3 | | vicinity | small | | bubble | vicinity | and large | |
| | | of the | bubbles | | grows | of the | bubble | |
| | | embedding | | | | embedding | | |
| | | portion | | | | portion | | |
| Comparative | Yes | In the | Dense | | Original | In the | Sparse | 2 |
| example 4 | | vicinity | small | | bubble | vicinity | large | |
| | | of the | bubbles | | grows | of the | bubble | |
| | | embedding | | | | embedding | | |
| | | portion | | | | portion | | |
| Comparative | No | / | / | / | Yes | In the | Dense | 1 |
| example 5 | | | | | | vicinity | small | |
| | | | | | | of the | bubble | |
| | | | | | | embedding | | |
| | | | | | | portion | | |

In examples 1 to 10, no bubbles are generated in the vicinity of the embedding portion 410 after the pressing and heat resistance test. In comparative example 5, no bubbles are generated after the pressing, but dense small bubbles are generated in the vicinity of the embedding portion after the heat resistance test. In comparative examples 1 to 4, bubbles are generated in the vicinity of embedding portion 410 after the pressing and heat resistance test. It can be seen that when the close contact value A is greater than or equal to 30, no bubbles are generated in the vicinity of the embedding portion 410 even after the pressing and heating, and when the close contact value A is less than 30, bubbles are generated in the vicinity of the embedding portion 410 after the pressing and heating.

When the close contact value A is greater than or equal to 20, the laminated glass does not generate bubbles after pressing, but generates bubbles after heating.

When the close contact value A is less than 20, for example, 19, 12, or 5, bubbles have been generated in the vicinity of the insertion portion 410 during the pressing process.

In an embodiment, an elastic modulus of the intermediate layer 300 is less than or equal to 10 MPa. The smaller the elastic modulus of the intermediate layer 300, the larger the deformation of the intermediate layer 300 when subjected to the same force. Therefore, when the elastic modulus of the middle layer 300 is set to be less than or equal to 10 MPa, even if the thickness of the second glass plate 200 is thin, the surface pressure that can be provided is small, however, the intermediate layer 300 can still fully cover an area around the embedding portion 410 to reduce the generation of bubbles.

In an embodiment, the embedding portion 410 includes a main body and an auxiliary bonding layer. When the embedding portion 410 is in contact with the first glass plate 100, the auxiliary bonding layer is provided between the main body and the first glass plate 100.

Alternatively, when the embedding portion 410 is in contact with the second glass plate 200, the auxiliary bonding layer is provided between the main body and the second glass plate 200. By the auxiliary bonding layer, the bonding between the embedding portion 410 and the first glass plate 100 or the second glass plate 200 can be improved, and the sealing performance can be improved.

Optionally, the thickness of the embedding portion 410 is the sum of a thickness of the main body and a thickness of the auxiliary bonding layer.

In an embodiment, the thickness of the auxiliary bonding layer is less than or equal to 0.3 mm. When the auxiliary bonding layer is less than or equal to 0.3 mm, the auxiliary bonding layer can improve the bonding and sealing effect, and has little influence on the thickness of the laminated glass.

In an embodiment, the embedding portion 410 has a rough surface configured to be bonded to the intermediate layer 300. The rough surface can increase the adhesive force when being bonded to the intermediate layer 300, so that the bonding is enhanced.

In an embodiment, the embedding portion 410 may be visually shielded by an opaque enamel strip provided on the first glass plate 100 and/or the second glass plate 200, such that the embedding portion is invisible on exterior and interior sides of the vehicle.

In an embodiment, when the intermediate layer 300 is a single-layer structure, all the embedding portions 410 are located between the intermediate layer 300 and the first glass plate 100. Alternatively, all the embedding portions 410 are located between the intermediate layer 300 and the second glass plate 200. Alternatively, all the embedding portions 410 are located in the intermediate layer 300.

When the intermediate layer 300 is a multi-layer structure, all the embedding portions 410 are located on the same side of the intermediate layer 300. Alternatively, the intermediate layer 300 includes at least two layers of split bodies, and all the embedding portions 410 are located between adjacent two split bodies. Since the embedding portions 410 need to be electrically connected to the built-in circuit on the intermediate layer 300, the embedding portions 410 should be provided on the same layer to be connected to the built-in circuit, respectively.

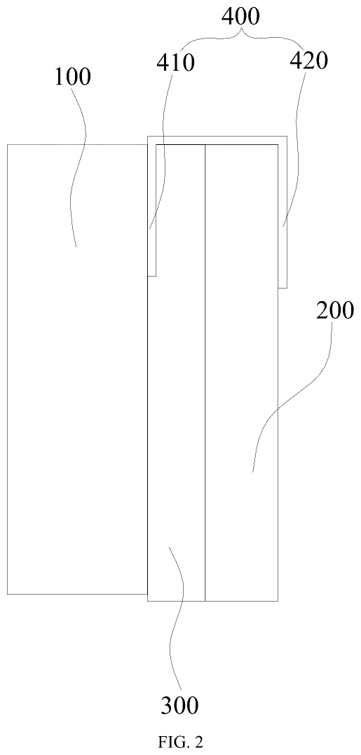

In an embodiment, as shown in FIG. 1 and FIG. 2, the connector 400 further includes an external connecting portion 420 connected to the embedding portion 410. The external connecting portion 420 is located outside the intermediate layer 300, and the external connecting portion 420 is bent toward the second glass plate 200 and is bonded to a side surface of the second glass plate 200 away from the intermediate layer 300. The external connecting portion 420 can be electrically connected to the external circuit, and the external connecting portion 420 is bent toward the second glass plate 200 and bonded to the side surface of the second glass plate 200 away from the intermediate layer 300, so that there is no gap between the external connecting portion 420 and the second glass plate 200, and the sealing performance is better, and impurities such as water and dust can be prevented from entering between the first glass plate 100 and the second glass plate 200 from between the external connecting portion and the second glass plate 200.

An embodiment provides a vehicle including the laminated glass according to any one of the above embodiments.

According to the vehicle, the intermediate layer 300 is located between the first glass plate 100 and the second glass plate 200, the connector 400 can be configured to be connected to the external circuit. The thickness of the embedding portion 410 is less than the thickness of the intermediate layer 300, such that the embedding portion 410 will not be in contact with the first glass plate 10 and the second glass plate 200 at the same time, so as to prevent pressing failure. The close contact value A is obtained by dividing a product of the thickness T₁ of the second glass plate 200, the thickness T₂ of the intermediate layer 300, and the distance L between the embedding portions 410 of the two adjacent connectors 400 by a cube of the thickness T₃ of the embedding portion 410. The close contact value A is ensured to be at least 20, at this time, even if the thickness of the second glass plate 200 is not greater than 1.2 mm, the surface pressure that the second glass plate 200 can provide during pressing is small, and the thickness of the embedding portion 410 may cause the intermediate layer 300 to partially protrude. However, after pressing and heating, bubbles are unlikely to be generated around the embedding portion 410, which provides a better appearance effect.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”. “bottom”, “inner”, “outer”, “clockwise”, “counterclockwise”, “axial”, “radial”, “circumferential direction” are based on the azimuth or position relationship shown in the attached drawings, which are only for the convenience of describing the present disclosure and simplifying the description, rather than indicating or implying that the device or element must have a specific azimuth, be constructed and operated in a specific azimuth, so such terms cannot be understood as a limitation of the present disclosure.

In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “a plurality of” means at least two, such as two, three, etc., unless otherwise expressly and specifically defined.

In the present disclosure, unless otherwise expressly specified and limited, the terms “mount”. “connect”. “contact”, “fix” and other terms should be understood in a broad sense, for example, they can be fixed connections, detachable connections, or integrated. They can be mechanical connection or electrical connection. They can be directly connected or indirectly connected through an intermediate medium. They can be the connection within two elements or the interaction relationship between two elements, unless otherwise expressly limited. For those skilled in the art, the specific meaning of the above terms in the present disclosure can be understood according to the specific situation.

In the present disclosure, unless otherwise expressly specified and limited, the first feature “above” or “below” the second feature may be in direct contact with the first and second features, or the first and second features may be in indirect contact through an intermediate medium. Moreover, the first feature is “above” the second feature, but the first feature is directly above or diagonally above the second feature, or it only means that the horizontal height of the first feature is higher than the second feature. The first feature is “below” of the second feature, which can mean that the first feature is directly below or obliquely below the second feature, or simply that the horizontal height of the first feature is less than that of the second feature.

It should be noted that when an element is called “fixed to” or “provided on” another element, it can be directly on another element or there can be a centered element. When an element is considered to be “connected” to another element, it can be directly connected to another element or there may be intermediate elements at the same time. The terms “vertical”, “horizontal”, “up”. “down”, “left”, “right” and similar expressions used herein are for the purpose of illustration only and do not represent the only embodiment.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

1. A laminated glass, comprising:
a first glass plate;
a second glass plate having a thickness no greater than 1.6 mm;
an intermediate layer provided between the first glass plate and the second glass plate; and
at least two connectors, each connector comprising an embedding portion provided between the intermediate layer and the second glass plate, and the embedding portion being in contact with both the intermediate layer and the second glass plate;
wherein the laminated glass has a close contact value A satisfying A=T₁×T₂×L/(T₃)³, and the close contact value A is at least 20, wherein T₁ is the thickness of the second glass plate, T₂ is a thickness of the intermediate layer, T₃ is a thickness of the embedding portion, and L is a distance between adjacent two embedding portions.

2. The laminated glass according to claim 1, wherein the thickness of the second glass plate is no greater than 1.2 mm.

3. The laminated glass according to claim 1, wherein the close contact value A is at least 30.

4. The laminated glass according to claim 3, wherein 0.5 mm≤T₁≤1.2 mm.

5. The laminated glass according to claim 3, wherein a thickness of the first glass plate is greater than or equal to 2.1 mm.

6. The laminated glass according to claim 1, wherein L≥5 mm.

7. The laminated glass according to claim 1, wherein 0.38 mm≤T₂≤1.52 mm.

8. The laminated glass according to claim 1, wherein 0.2 mm≤T₃≤1 mm.

9. The laminated glass according to claim 1, wherein an elastic modulus of the intermediate layer is less than or equal to 10 MPa.

10. The laminated glass according to claim 1, wherein the embedding portion comprises a main body and an auxiliary bonding layer, and when the embedding portion is in contact with the first glass plate, the auxiliary bonding layer is provided between the main body and the first glass plate;
or when the embedding portion is in contact with the second glass plate, the auxiliary bonding layer is provided between the main body and the second glass plate.

11. The laminated glass according to claim 10, wherein a thickness of the auxiliary bonding layer is less than or equal to 0.3 mm.

12. The laminated glass according to claim 1, wherein the embedding portion is provided with a rough surface configured to be bonded to the intermediate layer.

13. The laminated glass according to claim 1, wherein when the intermediate layer is a single-layer structure, the embedding portions are located between the intermediate layer and the first glass plate; or the embedding portions are located between the intermediate layer and the second glass plate; or the embedding portions are located in the intermediate layer;
when the intermediate layer is a multi-layer structure, the embedding portions are located on the same side of the intermediate layer; or the intermediate layer comprises at least two layers of split bodies, and all the embedding portions are located between adjacent two split bodies.

14. The laminated glass according to claim 1, wherein the connector further comprises an external connecting portion connected to the embedding portion, the external connecting portion is located outside the intermediate layer, and the external connecting portion is bent toward the second glass plate and is bonded to a side surface of the second glass plate away from the intermediate layer.

15. A vehicle comprising the laminated glass according to claim 1.
